(19) United States
(12) Patent Application Publication
(10) Pub. No.: US 2023/0017610 A1
(43) Pub. Date: Jan. 19, 2023

(54) MEMBER FOR OPTICAL GLASS MANUFACTURING APPARATUS

(71) Applicant: KYOCERA CORPORATION, Kyoto-shi, Kyoto (JP)

(72) Inventors: Masato HASHIMOTO, Kirishima-shi, Kagoshima (JP); Junya KOGA, Kirishima-shi, Kagoshima (JP); Toshikazu SAKIMOTO, Kirishima-shi, Kagoshima (JP)

(21) Appl. No.: 17/778,777

(22) PCT Filed: Nov. 19, 2020
(86) PCT No.: PCT/JP2020/043180

§ 371 Date: May 20, 2022

(30) Foreign Application Priority Data
Nov. 28, 2019 (JP) 2019-215723

(51) Int. Cl. C04B 35/584; C03B 37/014

(52) U.S. Cl. CPC C04B 35/584; C03B 37/01486; C04B 2235/3873; C04B 2235/3217; C04B 2235/9669

(57) ABSTRACT

Provided is a member for optical glass manufacturing apparatus. The member is used for optical glass manufacturing apparatus and exposed to a gas containing a halogen element in a high temperature environment of 1100° C. or higher. The member includes dense ceramics containing silicon nitride as a main component, and a porosity of a surface layer of the member is smaller than a porosity of the inside of the member.

### TECHNICAL FIELD

The disclosed embodiments relate to a member for optical glass manufacturing apparatus.

### BACKGROUND ART

A member used for an optical glass manufacturing apparatus that manufactures optical glass (hereinafter, also referred to as a member for optical glass manufacturing apparatus) may be exposed to a corrosive gas in a high temperature environment in the process of manufacturing such optical glass (see, for example, Patent Document 1).

### CITATION LIST

### Patent Literature

Patent Document 1: JP 07-29807 B

### SUMMARY

A member for optical glass manufacturing apparatus according to an aspect of an embodiment is a member, which is used for optical glass manufacturing apparatus and exposed to a gas containing a halogen element in a high temperature environment of 1100° C. or higher. The member includes dense ceramics containing silicon nitride as a main component, and a porosity of a surface layer of the member is smaller than a porosity of the inside of the member.

### BRIEF DESCRIPTION OF DRAWINGS

FIG. 1 is a diagram for describing a configuration of an optical glass manufacturing apparatus according to an embodiment.

FIG. 2 is a diagram for describing a configuration of an optical glass manufacturing apparatus according to an embodiment.

FIG. 3 is a SEM observed photograph of a polished surface on an outer peripheral side of a support body.

FIG. 4 is an SEM observed photograph of a polished surface at a center portion of a support body.

FIG. 5 is an SEM observed photograph of a polished surface on an inner peripheral side of a support body.

FIG. 6 is an SEM observed photograph of a fracture surface on an outer peripheral side of a support body.

FIG. 7 is an SEM observed photograph of a fracture surface at a center portion of a support body.

FIG. 8 is an SEM observed photograph of a fracture surface on an inner peripheral side of a support body.

### DESCRIPTION OF EMBODIMENTS

Hereinafter, embodiments of a member for optical glass manufacturing apparatus disclosed in the present application will be described with reference to the accompanying drawings. The present invention is not limited by the following embodiments.

A member used in an optical glass manufacturing apparatus that manufactures optical glass (hereinafter, also referred to as a member for optical glass manufacturing apparatus) may be exposed to a corrosive gas in a high temperature environment in the process of manufacturing such optical glass.

For example, in the process of manufacturing optical glass, the above-described member may be exposed to a gas containing a halogen element (e.g., F (fluorine), Cl (chlorine), and Br (bromine)) under a high temperature environment of 1100° C. or higher.

Since corrosion reaction by a corrosive gas is promoted in such a severe environment, a member for optical glass manufacturing apparatus with high corrosion resistance is required. However, in the related technology, there is room for enhancement of the corrosion resistance of a member for optical glass manufacturing apparatus used in such a severe environment.

Therefore, it is expected that a member for optical glass manufacturing apparatus with excellent corrosion resistance can be achieved by overcoming the above problems.

### Embodiment

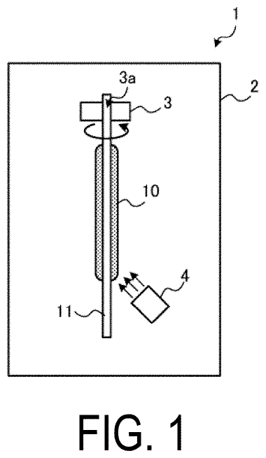

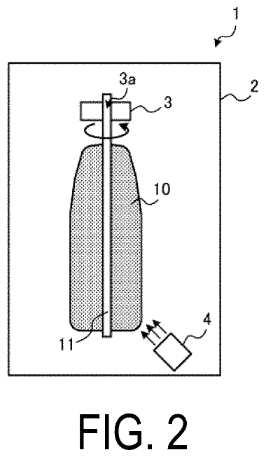

First, a configuration of an optical glass manufacturing apparatus 1 according to an embodiment will be described with reference to FIGS. 1 and 2. FIGS. 1 and 2 are diagrams for describing a configuration of an optical glass manufacturing apparatus 1 according to the embodiment.

FIG. 1 illustrates an initial stage in the manufacturing process of optical glass 10, and FIG. 2 illustrates a later stage in the manufacturing process of optical glass 10.

As illustrated in FIG. 1, the optical glass manufacturing apparatus 1 according to the embodiment includes a high temperature furnace 2, a support body 3, and a raw material supply portion 4, and the support body 3 and the raw material supply portion 4 are provided inside the high temperature furnace 2. The support body 3 is an example of a member for optical glass manufacturing apparatus.

The high temperature furnace 2 can form a high temperature environment (e.g., the temperature is from 1100° C. to 1600° C.) inside, which is required in a manufacturing process of the optical glass 10. The support body 3 supports a glass rod 11, which is a starting material for the optical glass 10.

In the support body 3, for example, an inserting portion 3a through which the glass rod 11 can be inserted is formed. The support body 3 is configured to be able to hold the glass rod 11 by the inserting portion 3a and rotate the held glass rod 11.

The raw material supply portion 4 is configured to supply raw material (e.g., SiClO₄, H₂, O₂, or the like) for the optical glass 10 to the glass rod 11. The raw material supply portion 4 is configured to supply a gas containing a halogen element (e.g., F₂ gas, Cl₂ gas, GeCl₄ gas, Br₂ gas, or the like) toward the glass rod 11 as the raw material of the additive element in the optical glass 10. Also, the raw material supply portion 4 is configured to be moveable inside the high temperature furnace 2.

As illustrated in FIG. 1, the optical glass 10 is formed on the surface of the glass rod 11, which is the starting material, by maintaining the inside of the high temperature furnace 2 at a predetermined temperature and supplying the raw material of the optical glass 10 from the raw material supply portion 4 toward the glass rod 11.

Further, by rotating the glass rod 11 using the support body 3 and moving the raw material supply portion 4 appropriately, the optical glass 10 can be grown in the peripheral of the glass rod 11 as illustrated in FIG. 2.

The optical glass 10 according to the embodiment is, for example, a microlens, a photomask, a selective absorption transmission glass, an optical fiber, or the like.

In the manufacturing process of the optical glass 10, various characteristics (e.g., index of refraction) of the optical glass 10 can be controlled by setting the inside of the high temperature furnace 2 to a high temperature environment of 1100° C. to 1600° C. and supplying a gas containing a halogen element from the raw material supply portion 4.

In the embodiment described above, the support body 3 includes dense ceramics whose main component is silicon nitride (Si₃N₄), and a porosity of the surface layer is smaller than a porosity of the inside. By configuring the support body 3 with such dense ceramics, it is possible to make it difficult for a corrosive gas to enter the inside from the pore in the surface layer directly exposed to the corrosive gas containing the halogen element. The surface layer may be a region within 2 mm in the depth direction from the surface. Further, the inside may be a region deeper than 2 mm in the depth direction from the surface.

Therefore, the embodiment enables improvement of the corrosion resistance of the support body 3 by preventing the corrosive gas from corroding the inside of the support body 3. In the present disclosure, “corrosion” is a phenomenon in which the weight of the member decreases and the porosity of the member increases simultaneously, by reacting with a gas containing a halogen element.

In the embodiment, the thermal shock resistance of the support body 3 can be improved because the propagation of the crack from the surface layer can be stopped by the pore of the inside by making the porosity of the inside in the support body 3 larger than that of the surface layer.

Further, in the embodiment, since the porosity of the inside in the support body 3 is made larger than that of the surface layer and the coefficient of thermal conductivity in the inside can be reduced, the escape of heat from the glass rod 11 through the support body 3 can be suppressed.

Therefore, the embodiment enables stable manufacture of the optical glass 10 by stabilizing the temperature of the optical glass 10 formed on the glass rod 11.

In the embodiment, the porosity of the surface layer in the support body 3 is preferably from 1 (area %) to 3 (area %). By configuring the support body 3 with dense ceramics having a small porosity of the surface layer in this way, it is possible to make it difficult for a corrosive gas containing a halogen element to penetrate further into the inside from the pore.

Therefore, the embodiment enables further improvement of the corrosion resistance of the support body 3 by further preventing the corrosive gas from corroding the inside of the support body 3.

Also, in the embodiment, the porosity of the inside in the support body 3 is preferably from 4 (area %) to 9 (area %). Thus, by configuring the support body 3 with dense ceramics having a relatively large porosity of the inside, the thermal shock resistance of the support body 3 can be further improved and the optical glass 10 can be more stably manufactured.

In the present disclosure, a “pore” observed in the cross section is a “closed pore”. Therefore, a porosity in the present disclosure is a porosity of the closed pore.

Also, in the embodiment, the average crystal grain size of the surface layer in the support body 3 is preferably greater than the average crystal grain size of the inside. Since the total length of the crystal grain boundaries in the surface layer can be shortened by configuring the support body 3 with such dense ceramics, it is possible to make it difficult for a corrosive gas containing a halogen element to enter the inside from the crystal grain boundaries.

Therefore, the embodiment enables improvement of the corrosion resistance of the support body 3 by preventing the corrosive gas from corroding the inside of the support body 3.

Also, in the embodiment, an oxygen content of the surface layer in the support body 3 is preferably less than an oxygen content of the inside. By configuring the support body 3 with such dense ceramics, it is possible to suppress the reaction between the gas containing a halogen element (e.g., chlorine), which is easy to react with the oxygen, and the oxygen existing in the surface layer.

Therefore, the embodiment enables improvement of the corrosion resistance of the support body 3 by preventing the corrosive gas which is easy to react with oxygen from corroding the surface layer in the support body 3.

In the embodiment, the oxygen content of the surface layer in the support body 3 is preferably 7.0 (mass %) or less, and the oxygen content of the surface layer in the support body 3 is more preferably 6.5 (mass %) or less.

This enables further improvement of the corrosion resistance of the support body 3 by preventing a corrosive gas which is easy to react with oxygen from corroding the surface layer in the support body 3. In the embodiment, an oxygen content of the inside in the support body 3 is preferably 7.1 (mass %) or more.

Also, in the embodiment, an aluminum content of the surface layer in the support body 3 is preferably less than an aluminum content of the inside.

By configuring the support body 3 with such dense ceramics, it is possible to suppress the reaction between the gas containing a halogen element (e.g., chlorine), which is easy to react with aluminum, and aluminum existing on the surface layer.

Therefore, the embodiment enables improvement of the corrosion resistance of the support body 3 by preventing the corrosive gas which easily reacts with aluminum from corroding the surface layer in the support body 3.

Also, in the embodiment, the aluminum content of the inside in the support body 3 may be greater than the aluminum content of the surface layer. By configuring the support body 3 with such dense ceramics, it is possible to make it difficult to propagate the crack to the inside even in the case where the support body 3 is dropped when handled, or even in the case where a crack is generated in the surface layer portion by impact applied to the surface when a portion of the support body 3 is hit.

This is because when an aluminum having a larger heat expansion than that of silicon nitride is present in the crystal grain boundary of silicon nitride, the aluminum of the grain boundary expands and a force (compressive stress) is always applied to push the silicon nitride grain outward from the grain boundary, strengthening the structure, and the inside has a high fracture toughness.

Further, in the embodiment, even when the surface layer portion is ground and the portion that was initially inside appears on the surface, a high fracture toughness can be imparted in the surface section, so that even when an impact is applied from the external, a crack can be made less likely to occur in the surface.

In the embodiment, the aluminum element contained in the surface layer portion of the dense ceramics may be reacted with other elements in the crystal grain boundary of the silicon nitride to exist as the crystal of the compound.

Examples of such compound crystal include Y₂SiAlO₅N, Y₄SiAlO₈N, or the like.

In this way, the corrosion resistance can be further improved because the reactivity of the aluminum element with the halogen is reduced by reacting the aluminum element contained in the dense ceramics containing the silicon nitride as a main component with other elements and allowing the aluminum element to exist as chemically stable crystal.

Since, in the dense ceramics that constitute the support body 3, alumina (Al₂O₃) is used as the sintering aid in sintering silicon nitride as the main component, oxygen and aluminum atoms exist on the surface and at the inside of the support body 3.

### EXAMPLES

Examples of the present disclosure will be specifically described below. The present disclosure is not limited to the following examples.

First, a metal silicon powder having an average particle size of 3 μm, a silicon nitride powder having an average particle size of 1 μm and a beta ratio of 10% (i.e., alpha ratio of 90%), an alumina powder having an average particle size of 0.5 μm or less, and an yttria powder having an average particle size of 1 μm (Y₂O₃) were prepared. Each prepared powder was mixed at a predetermined ratio to yield a mixed powder.

The resulting mixed powder was then placed in a barrel mill with a grinding medium including water and a silicon nitride-based sintered compact and mixed and ground to a predetermined particle size. Then, a slurry was produced by adding polyvinyl alcohol (PVA), which is an organic binder, at a predetermined ratio to the mixed powder which had been mixed and ground.

The resulting slurry was then sieved through a mesh sieve having a predetermined particle size and then granulated using a spray-drying granulator to yield granules. The resulting granules were compacted into a predetermined shape (in the present disclosure, a tubular shape including the inserting portion 3a) by cold isotropic pressure (CIP) molding at a molding pressure of 60 MPa to 100 MPa to yield a compact.

The resulting compact was then placed in a silicon carbide mortar and degreased by holding the compact at 500° C. for 5 hours in a nitrogen atmosphere. Subsequently, the temperature was increased further, and nitriding was carried out by successively holding the compact at 1050° C. for 20 hours and at 1250° C. for 10 hours, in a nitrogen partial pressure of 150 kPa substantially composed of nitrogen.

Then, the pressure of the nitrogen was set to normal pressure, the temperature was further increased, and the firing was performed at 1700° C. to 1800° C. for 2 hours or more. Finally, the support body 3 of dense ceramics containing silicon nitride as a main component was produced by cooling at a predetermined temperature decrease rate as low as 10° C/min or less, from a maximum temperature at the time of firing to 1000° C. The support body 3 may be, for example, 80 mm in outer diameter, 40 mm in inner diameter, and 100 mm in length.

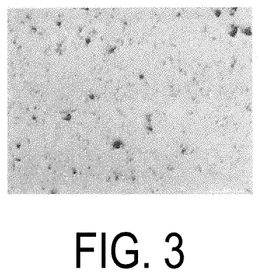

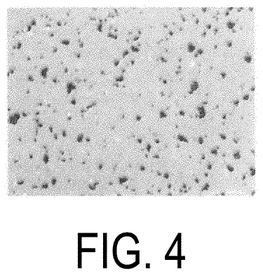

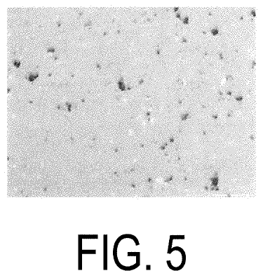

Then, polished surfaces on the outer peripheral side (an example of the surface layer of the support body 3), at the center portion (an example of the inside of the support body 3), and on the inner peripheral side (an example of the surface layer of the support body 3), in the resulting tubular support body 3, were observed by a scanning electron microscope (SEM). FIGS. 3 to 5 are SEM observed photographs of the polished surfaces on the outer peripheral side, at the center portion, and on the inner peripheral side, in the support body 3, respectively. In the SEM observed photographs illustrated in FIGS. 3 to 5, a portion in dark color represents a pore.

Next, the number of pores per unit area for each observed portion, porosity, an average diameter of pores, and a maximum diameter of pores were evaluated using the obtained SEM observed photographs. Specifically, first, the contour of the pore detected in dark color is outlined in black using the obtained SEM observed photograph.

Next, the number of pores per unit area, the average diameter of pores, and the maximum diameter of pores can be determined by performing image analysis by applying a technique called “particle analysis” provided by the image analysis software “Azo-kun” (trade name, product of Asahi Kasei Engineering Cooperation, hereinafter image analysis software “Azo-kun” is referred to image analysis software of Asahi Kasei Engineering Cooperation) using a bordered image or photograph.

Similarly, by applying the “particle analysis” provided by the image analysis software “Azo-kun” to perform image analysis, a total area of a plurality of pores can bedetermined, and “porosity” can be determined based on the ratio of the total area of the plurality of pores to the unit area.

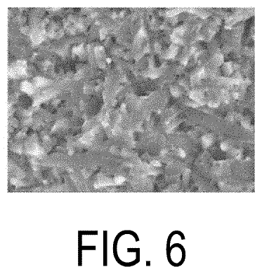

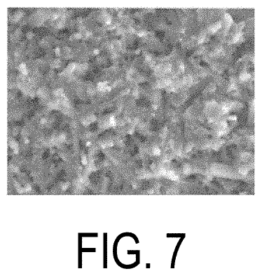

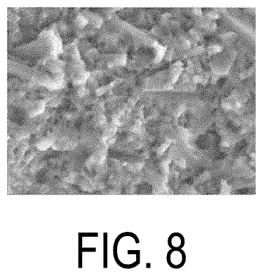

The fracture surfaces on the outer peripheral side, at the center portion, and on the inner peripheral side, in the tubular support body 3 were observed by SEM. FIGS. 6 to 8 are SEM observed photographs of the fracture surfaces of the outer peripheral side, the center portion, and the inner peripheral side, in the support body 3, respectively.

Additionally, the resulting tubular support body 3 was evaluated for the oxygen content and the aluminum content on the outer peripheral side, at the center portion, and on the inner peripheral side, in the tubular support body 3. The oxygen content was evaluated by an infrared absorption method using an oxygen analyzer (EMGA-650FA manufactured by HORIBA, Ltd.). The aluminum content was evaluated using an inductively coupled plasma (ICP) emission spectrophotometer or an X-ray fluorescence spectrometer.

Here, Table 1 shows, for each observed portion of the support body 3, the evaluation results of the number of pores per unit area, the porosity, the average diameter of pores, the maximum diameter of pores, the oxygen content, and the aluminum content.

TABLE 1

| | NUMBER | | AVERAGE | MAXIMUM | | |
|---|---|---|---|---|---|---|
| | OF PORES | | DIAMETER | DIAMETER | OXYGEN | ALUMINUM |
| OBSERVED | PER UNIT | POROSITY | OF PORES | OF PORES | CONTENT | CONTENT |
| PORTION | AREA | (area %) | (μm) | (μm) | (mass %) | (mass %) |
| OUTER | 3289 | 2.1 | 2.0 | 14.2 | 6.2 | 1.9 |
| PERIPHERAL | | | | | | |
| SIDE | | | | | | |
| CENTER | 2764 | 5.3 | 3.9 | 18.4 | 7.3 | 2.0 |
| PORTION | | | | | | |
| INNER | 1672 | 1.6 | 2.5 | 14.0 | 7.0 | 1.8 |
| PERIPHERAL | | | | | | |
| SIDE | | | | | | |

As shown in Table 1 and FIGS. 3 to 5, in the support body 3 according to the embodiment, it can be seen that the porosity of the surface layer (i.e., the outer peripheral side and the inner peripheral side) is smaller than the porosity of the inside (i.e., the center portion). This can prevent the corrosive gas from entering the inside from the pore in the surface layer directly exposed to a corrosive gas containing the halogen element.

Therefore, the embodiment enables improvement of the corrosion resistance of the support body 3 by preventing the corrosive gas from corroding the inside of the support body 3.

As a technique for making the porosity of the surface layer in the support body 3 smaller than the porosity of the inside layer, it is effective to perform CIP molding at a high molding pressure (60 MPa to 100 MPa) or to perform a firing process in a nitrogen atmosphere of the normal pressure.

As illustrated in FIGS. 6 to 8, in the support body 3 according to the embodiment, it is understood that the average crystal grain size of the surface layer (i.e., the outer peripheral side and the inner peripheral side) is larger than the average crystal grain size of the inside (i.e., the center portion). This makes it possible to shorten the total length of the crystal grain boundaries in the surface layer, thereby making it difficult for the corrosive gas containing the halogen element to enter the inside from the crystal grain boundaries.

Therefore, the embodiment enables improvement of the corrosion resistance of the support body 3 by preventing the corrosive gas from corroding the inside of the support body 3.

As a technique for making the average crystal grain size of the surface layer in the support body 3 larger than the average crystal grain size of the inside, it is effective to perform a firing process at 1700° C. to 1800° C. for 2 hours or more, or the like.

Also, as shown in Table 1, in the support body 3 according to the embodiment, it can be seen that oxygen content of the surface layer (i.e., the outer peripheral side and the inner peripheral side) is lower than that of the inside (i.e., the center portion). This makes it possible to suppress the reaction between the gas containing a halogen element (e.g., chlorine), which is easy to react with the oxygen, and the oxygen existing in the surface layer.

Therefore, the embodiment enables improvement of the corrosion resistance of the support body 3 by preventing the corrosive gas which is easy to react with oxygen from corroding the surface layer in the support body 3.

As a technique for reducing oxygen content of the surface layer in the support body 3 to be less than the oxygen content of the inside, it is effective to perform a firing process in a firing container containing carbon.

As shown in Table 1, in the support body 3 according to the embodiment, it can be seen that the oxygen content of the surface layer (i.e., the outer peripheral side and the inner peripheral side) is 7.0 (mass %) or less. This enables improvement of the corrosion resistance of the support body 3 by preventing the corrosive gas which is easy to react with oxygen from corroding the surface layer in the support body 3.

Also, as shown in Table 1, in the support body 3 according to the embodiment, it can be seen that the aluminum content of the surface layer (i.e., the outer peripheral side and the inner peripheral side) is lower than the aluminum content of the inside (i.e., the center portion). This can prevent a gas containing a halogen element (e.g., chlorine), which is easy to react with aluminum, from reacting with aluminum existing on the surface layer.

Therefore, the embodiment enables improvement of the corrosion resistance of the support body 3 by preventing the corrosive gas which easily reacts with aluminum from corroding the surface layer in the support body 3.

As a technique for reducing the aluminum content of the surface layer in the support body 3 to less than the aluminum content of the inside, it is effective to use alumina and yttria as the sintering aid.

The present invention has been described above, however, is not limited to the above-described embodiments, and various changes can be made as long as the present invention does not deviate from the spirit thereof. For example, in the embodiment described above, dense ceramics of the present disclosure are applied to the support body 3 supporting the glass rod 11, but may be applied to the members other than the support body 3 in the optical glass manufacturing apparatus 1.

Further, in the embodiment described above, dense ceramics of the present disclosure are applied to the member for the optical glass manufacturing apparatus, but the apparatus to which dense ceramics of the present disclosure is applied is not limited to the optical glass manufacturing apparatus 1, and may be applied to various other apparatuses as long as the member is used for a portion exposed to a gas containing a halogen element under a high temperature environment.

Further effects and other embodiments can be readily derived by those skilled in the art. Thus, the broader aspects of present invention are not limited to the specific details and representative embodiments represented and described above. Accordingly, various changes may be made without departing from the spirit or scope of the general inventive concept as defined by the appended claims and their equivalents.

### REFERENCE SIGNS LIST

1 Optical glass manufacturing apparatus
2 High temperature furnace
3 Support body (Example of member for optical glass manufacturing apparatus)
3a Inserting portion
4 Raw material supply portion
10 Optical glass
11 Glass rod

1. A member for optical glass manufacturing apparatus, the member exposed to a gas containing a halogen element in a high temperature environment of 1100° C. or higher, the member comprising:
dense ceramics containing silicon nitride as a main component, wherein
a porosity of a surface layer of the member is smaller than a porosity of the inside of the member.

2. The member for optical glass manufacturing apparatus according to claim 1, wherein
an average crystal grain size of the surface layer is greater than an average crystal grain size of the inside.

3. The member for optical glass manufacturing apparatus according to claim 1, wherein
an oxygen content of the surface layer is less than an oxygen content of the inside.

4. The member for optical glass manufacturing apparatus according to claim 1, wherein
the dense ceramics contain alumina as a sintering aid, and
an aluminum content of the surface layer is less than an aluminum content of the inside.

5. The member for optical glass manufacturing apparatus according to claim 4, wherein,
in crystal grain boundaries of the silicon nitride, an aluminum element contained in a surface layer portion of the dense ceramics is present as a crystal of a compound.
